(19) United States
(12) Patent Application Publication
(10) Pub. No.: US 2017/0172336 A1
(43) Pub. Date: Jun. 22, 2017

(54) INTEGRATED COOKING SYSTEM WITH PIANO MUSIC PLAYER

(71) Applicant: Jean-Marc Hardy, Brooklyn, NY (US)

(72) Inventor: Jean-Marc Hardy, Brooklyn, NY (US)

(21) Appl. No.: 15/424,784

(22) Filed: Feb. 4, 2017

(51) Int. Cl. A47J 27/14; G10C 3/02; A47J 36/00; A47J 36/02; A47J 37/06

(52) U.S. Cl. CPC A47J 27/14; A47J 36/02; A47J 37/0629; A47J 36/00; G10C 3/02

(57) ABSTRACT

The embodiments herein provide a piano cuisine apparatus for integrating music and food. The apparatus comprises a wooden case in the shape of a piano for housing a musical keyboard. Different musical sounds are generated upon pressing each key in the musical keyboard. The hot plates are attached on the top surface of the wooden case for providing a flat heating surface for cooking or reheating the food. The shelves are attached to the wooden case for providing an open storage space to store the cooking related items. Drawers are provided within the wooden case for providing an enclosed storage space for storing the cooking related items. A sink is attached on top surface of the wooden case for providing a bowl-shaped plumbing fixture for washing hands, dishwashing, and other similar purposes while cooking.

### BACKGROUND

Technical Field

The embodiments herein are generally related to the field of restaurant, hotel, food and music. The embodiments herein are particularly related to a system and method for integrating kitchen with a musical instrument such as a piano. The embodiments herein are more particularly related to development of a piano cuisine apparatus by integrating piano into kitchen counter.

Description of the Related Art

Cooking/making food requires a whole lot of space and requires managing multiple items/things such as cook-tops or heating plates, vessels, ingredients, water containers and dispensers, washing area or sink and the like. The whole activity of cooking or making a dish consumes a lot of time and thus becomes boring or monotonous job at times.

In order to make cooking interesting and to overcome this boringness, there are several cook-tops that are currently available with inbuilt music systems/players for listening to music while cooking. Also, some people even have the hobby/habit of singing or making their own music or karaoke while indulging in other activities such as cooking and washing thereby creating a need of environment for carrying out both the cooking and music activities simultaneously. Moreover, the customers need to wait for a considerable time after placing an order for food/beverages, in places such as restaurants. as a result the customers usually gets bored while waiting for their food and have no activity for engaging themselves except listening to music.

Hence, there is a need for developing a single integrated platform or cooking range or instrument for providing cooking and music activities simultaneously. Further, there is a need for integrating kitchen with a musical instrument such as a piano. Yet there is a need for development of a piano cuisine comprising a keyboard, a hot plate, a shelf, a drawer, and a sink. Further, there is a need for a piano cuisine which is used by the chefs in places like restaurants for cooking as well as playing live music to entertain customers with food and music.

The above mentioned shortcomings, disadvantages and problems are addressed herein and which will be understood by reading and studying the following specification.

### OBJECTS OF THE EMBODIMENTS

The primary object of the embodiments herein is to provide an integrated cooking range and musical player such as piano.

Another object of the embodiments herein is to provide an integrated kitchen with a musical instrument such as a piano.

Yet another object of the embodiments herein is to provide an integrated cooking system with a piano cuisine apparatus comprising a keyboard, a hot plate, a shelf, a drawer, and a sink.

Yet another object of the embodiments herein is to provide an integrated cooking system with a piano music player, which is used by the chefs in places like restaurants for cooking as well as playing live music for entertaining customers with delicious foods and pleasant or rocking music.

Yet another object of the embodiment herein is to provide an integrated cooking system with a piano music player which is used by the chef in places like restaurant to entertain the guests while cooking the food thereby contributing indirectly in increasing business/revenue for the restaurant.

Yet another object of the embodiments herein is to provide an integrated cooking system with a piano music player which is used as a kitchen island.

Yet another object of the embodiments herein is to provide an integrated cooking system with a piano music player which is used to entertain the guests with a chef preparing food and a piano player playing music wherein both individuals are engaged in playing a song/melody in rhythm and exhibit one skills in cooking and playing the piano simultaneously.

Yet another object of the embodiments herein is to provide an integrated cooking system with a piano music player which provides space for displaying advertisements and promotions for applications such as catering, eatery, concerts, trade shows and the like.

Yet another object of the embodiments herein is to provide an integrated cooking system with a piano music player to enable the user to develop a melody, harmony, music or music album while preparing a recipe.

Yet another object of the embodiments herein is to provide an integrated cooking system with a piano music player which offers a sufficient storage space in the form of open shelves or enclosed drawers for keeping/storing the cooking related items.

Yet another object of the embodiments herein is to provide an integrated cooking system with a piano music player comprising a bowl-shaped plumbing fixture such as a sink for washing hands, dishwashing, and other similar purposes while cooking.

Yet another object of the embodiments herein is to provide an integrated cooking system with a piano music player comprising an electric oven accommodated within the wooden case which is used for cooking, baking or reheating the food.

These and other objects and advantages of the embodiments herein will become readily apparent from the following detailed description taken in conjunction with the accompanying drawings.

### SUMMARY

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

The various embodiments herein provide an integrated cooking system with a piano music player for integrating music and food. The apparatus comprises a wooden case configured for accommodating a musical keyboard having plurality of keys. The musical keyboard is configured for generating a plurality of musical sounds upon pressing of each key. The wooden case is formed in a shape of a piano. The apparatus also comprises one or more hot plates and one or more shelves. The one or more hot plates are attached to or mounted on a top surface of the wooden case and configured for providing a flat heating surface for cooking or reheating a food. The one or more shelves are attached to the wooden case and configured for providing an open storage space to store a plurality of cooking related items. The apparatus further comprises one or more drawers provided within the wooden case and configured for providing an enclosed storage space for storing the plurality of cooking related items. A sink is mounted on a top/upper surface of the wooden case and configured for providing a bowl-shaped plumbing fixture for washing hands, dishwashing, and other similar purposes while cooking.

According to an embodiment herein, the one or more hot plates are made up of metal or ceramic material.

According to an embodiment herein, the wooden case is made up of material such as fabric, wood, marble, metal, plastic and the like.

According to an embodiment herein, the apparatus is further configured for enabling the user to develop a melody, harmony, music or music album using the musical keyboard while preparing a recipe.

According to an embodiment herein, the apparatus is further configured for providing sufficient open space for keeping additional things required while cooking. The additional things comprise a butcher block, a chopping board, a set of knives, and the like.

According to an embodiment herein, the one or more shelves are customizable in size and design based on a user requirement.

According to an embodiment herein, the apparatus further comprises a multi stage height adjustment unit. The multi stage height adjustment unit is configured to adjust height of the one or more shelves based on a user requirement.

According to an embodiment herein, the apparatus is further configured for offering space for displaying advertisements, promotions and the like.

According to an embodiment herein, the apparatus further comprises an electric oven arranged or mounted within the wooden case. The electric oven is configured for providing a medium for cooking, baking or reheating the food.

According to an embodiment herein, the piano cuisine apparatus further comprises a water tap attached to the sink. The water tap is configured for providing water for washing or cooking purpose.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

### BRIEF DESCRIPTION OF THE DRAWINGS

The other objects, features and advantages will occur to those skilled in the art from the following description of the preferred embodiment and the accompanying drawings in which:

FIG. 1 illustrates a top view of an integrated cooking system with piano player such as piano cuisine apparatus, according to one embodiment herein.

FIG. 2 illustrates a side view of the piano cuisine apparatus, according to one embodiment herein.

FIG. 3 illustrates a side view of the multi stage height adjustment unit mounted in the piano cuisine apparatus, according to one embodiment herein.

Although the specific features of the present invention are shown in some drawings and not in others. This is done for convenience only as each feature may be combined with any or all of the other features in accordance with the embodiments herein.

### DETAILED DESCRIPTION OF THE EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide an integrated cooking system with a piano music player for integrating music and food. The apparatus comprises a wooden case configured for accommodating a musical keyboard having plurality of keys. The musical keyboard is configured for generating a plurality of musical sounds upon pressing of each key. The wooden case is formed in a shape of a piano. The apparatus also comprises one or more hot plates and one or more shelves. The one or more hot plates are attached to or mounted on a top surface of the wooden case and configured for providing a flat heating surface for cooking or reheating a food. The one or more shelves are attached to the wooden case and configured for providing an open storage space to store a plurality of cooking related items. The apparatus further comprises one or more drawers provided within the wooden case and configured for providing an enclosed storage space for storing the plurality of cooking related items. A sink is mounted on a top/upper surface of the wooden case and configured for providing a bowl-shaped plumbing fixture for washing hands, dishwashing, and other similar purposes while cooking.

According to an embodiment herein, the one or more hot plates are made up of metal or ceramic material.

According to an embodiment herein, the wooden case is made up of material such as fabric, wood, marble, metal, plastic and the like.

According to an embodiment herein, the apparatus is further configured for enabling the user to develop a melody, harmony, music or music album using the musical keyboard while preparing a recipe.

According to an embodiment herein, the apparatus is further configured for providing sufficient open space for keeping additional things required while cooking. The additional things comprise a butcher block, a chopping board, a set of knives, and the like.

According to an embodiment herein, the one or more shelves are customizable in size and design based on a user requirement.

According to an embodiment herein, the apparatus further comprises a multi stage height adjustment unit. The multi stage height adjustment unit is configured to adjust height of the one or more shelves based on a user requirement.

According to an embodiment herein, the apparatus is further configured for offering space for displaying advertisements, promotions and the like.

According to an embodiment herein, the apparatus further comprises an electric oven arranged or mounted within the wooden case. The electric oven is configured for providing a medium for cooking, baking or reheating the food.

According to an embodiment herein, the piano cuisine apparatus further comprises a water tap attached to the sink. The water tap is configured for providing water for washing or cooking purpose.

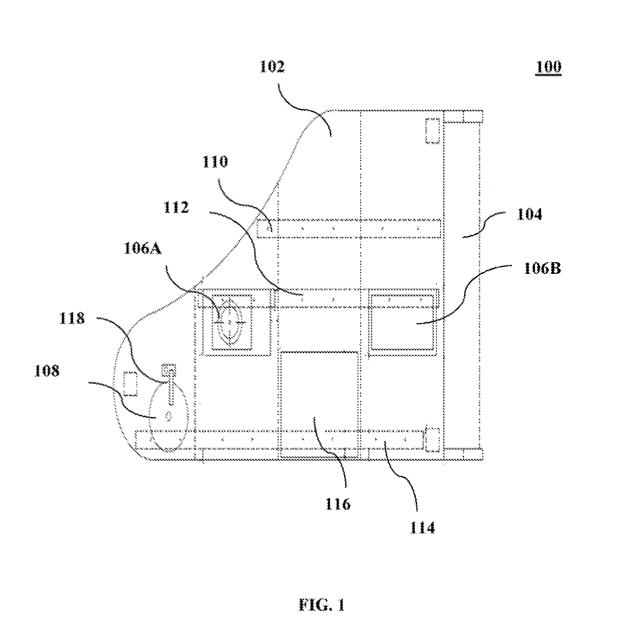

FIG. 1 illustrates a top side plan view of the piano cuisine apparatus, according to one embodiment herein. With respect to FIG. 1, the internal structure of the piano cuisine apparatus is depicted. The piano cuisine apparatus 100 comprises a wooden case 102 configured for accommodating a musical keyboard (not shown) having plurality of keys. The musical keyboard is configured for generating different musical sounds on pressing of each key. The wooden case is in the shape of a piano having a side panel 104 to accommodate the musical keyboard. The piano cuisine apparatus also comprises one or more hot plates such as 106A and 106B attached on the top surface of the wooden case 102 configured for providing a flat heating surface for cooking or reheating the food. The one or more hot plates are made up of metal or ceramic material.

According to an embodiment herein, the wooden case is manufactured using material such as fabric, wood, marble, metal, plastic and the like. In one example embodiment, the wooden case of the piano cuisine apparatus is manufactured using high gloss black plastic laminate.

According to an embodiment herein, the piano cuisine apparatus 100 further comprises one or more shelves (not shown) attached to the wooden case 102 that are configured for providing an open storage space to store plurality of cooking related items. The piano cuisine apparatus 100 further comprises one or more drawers (not shown) provided within the wooden case configured for providing an enclosed storage space for storing plurality of cooking related items. A sink 108 is attached on top surface of the wooden case 102 and is configured for providing a bowl-shaped plumbing fixture for washing hands, dishwashing, and other similar purposes while cooking.

According to an embodiment herein, one or more thick steel plates 110, 112 and 114 are placed as shown for bearing the weight of heavy cooking related items such as pressure cooker, utensils placed inside the water sink and the like. The one or more steel plates in the piano cuisine apparatus are configured for increasing the load bearing capacity of the top surface of the apparatus and for making sure the weight is equally distributed across the surface area. In one example embodiment, the one or more steel plates are about 3 inch wide and ¼ inch thicker.

According to an embodiment herein, the piano cuisine apparatus 100 further provides sufficient open space for keeping additional things required while cooking. The additional things comprise a butcher block 116, a chopping board (not shown), a set of knives (not shown), and the like. The open space is also used for serving the food prepared by the chef.

According to an embodiment herein, the piano cuisine apparatus 100 is further configured for enabling the user to develop a melody, harmony, music or music album while preparing a recipe. The piano cuisine apparatus is further configured for offering space for display of advertisements, promotions and the like. The piano cuisine apparatus further comprises an electric oven (not shown) accommodated within the wooden case. The electric oven is configured for providing a medium for cooking, baking or reheating the food.

According to an embodiment herein, the piano cuisine apparatus further comprises a water tap 118 attached to the sink 108. The water tap 118 is configured for providing water for washing or cooking purpose

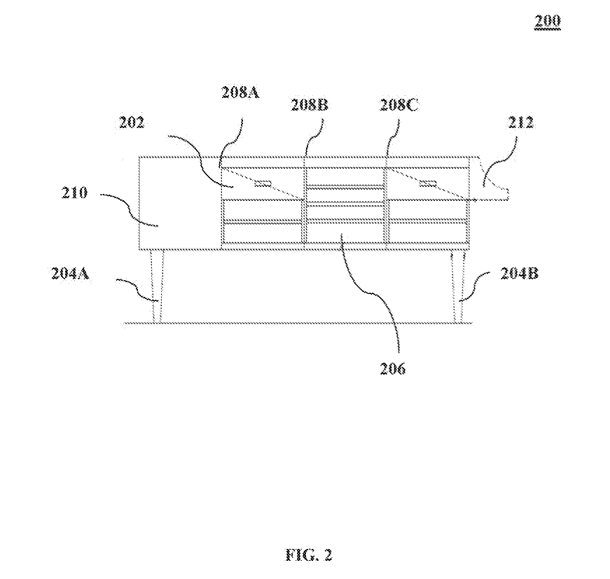

FIG. 2 illustrates a side view of the piano cuisine apparatus, according to one embodiment herein. With respect to FIG. 2, the various parts of the piano cuisine apparatus are shown. As explained earlier, one or more shelves 202 of different size and depth are provided. The one or more shelves 202 are customizable in size and shape as per user requirement. The shelves are attached to the wooden case for providing an open storage space to store plurality of cooking related items. The wooden case also comprises a plurality of legs 204A-204B for providing stability to the piano cuisine apparatus on any surface. The piano cuisine apparatus further comprises one or more drawers 206 provided within the wooden case for providing an enclosed storage space for storing plurality of cooking related items

According to an embodiment herein, the seams/joints 208A-208C of the various wooden blocks are attached using z clips (not shown). The z clip offers a cost effective and easy solution for installation. Further, a false panel 210 is provided to improve the aesthetics/appearance of the piano cuisine apparatus. The piano cuisine apparatus is further provided with removable sides 212 for enabling the user to place the musical keyboard in desired direction of the apparatus.

According to an embodiment herein, the various parts of the piano cuisine apparatus are customizable in sizes. In one example embodiment, the bigger shelf is about the size of 26 inches while the smaller shelf is 7 inches. Also, the height of the piano cuisine apparatus is about 36 inches while height of the base of piano cuisine apparatus from the ground is about 16 inches and that of false panel is 20 inches.

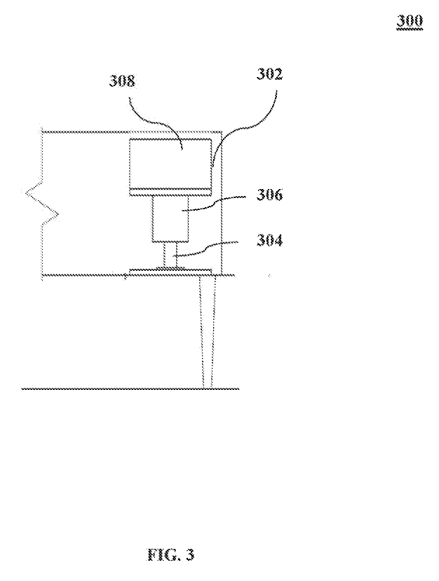

FIG. 3 illustrates a side view of a multi stage height adjustment unit used in the piano cuisine apparatus, according to one embodiment herein. With respect to FIG. 3, the multi stage height adjustment unit 302 is configured for adjusting a height of the one or more shelves.

According to an embodiment herein, the multi stage height adjustment unit 302 is extended or contracted in height to achieve the desired height of the piano cuisine apparatus. In this example embodiment, each stage 304, 306 and 308 is extended completely to achieve a maximum height of the piano cuisine apparatus as shown. Minimum height (not shown) of the piano cuisine apparatus is achieved by contracting all the stages so that the bigger stage area such as 308 accommodates the smaller stage areas on contraction.

Therefore, the piano cuisine apparatus of the proposed invention provides a seamless integration of a musical instrument such as piano with food. The piano cuisine apparatus is formed by integrating a musical keyboard with hot plates, shelves, drawers and a sink. This piano cuisine apparatus is used for entertainment purpose in places like restaurants, bars, outdoor recreational places etc. The chefs are facilitated to prepare food while playing music in order to entertain the customers. The purpose of the piano cuisine apparatus is to entertain the guests with a chef preparing food and a piano player playing a music. Both the individuals play a song/melody in rhythm and showcase/exhibit the skills of cooking and playing the piano at the same time. The chef not only prepares the food, but he also plays as a percussionist using the kitchen instruments.

The embodiments herein enhance the conventional cooking experience of the users by allowing them to create melodies while spending time in the kitchen. The integrated cooking system with piano music player is used for a varied range of applications such as for advertisement, promotion, catering, eatery, concert, and trade shows.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. An integrated cooking system with a piano music player apparatus for integrating music and food, the apparatus comprising:
a wooden case configured for accommodating a musical keyboard having plurality of keys, and wherein the musical keyboard is configured for generating a plurality of mutually different musical sounds when each key is pressed, and wherein the wooden case is formed in a shape of a piano;
one or more hot plates attached or mounted on a top surface of the wooden case, and wherein the one or more hot plates are configured for providing a flat heating surface for cooking or reheating a food;
one or more shelves attached to the wooden case, and wherein the one or more shelves are configured for providing an open storage space to store a plurality of cooking related items;
one or more drawers provided within the wooden case. and wherein the one or more drawers are configured for providing an enclosed storage space for storing the plurality of cooking related items; and
a sink attached or mounted on the top surface of the wooden case, and wherein the sink is configured for providing a bowl-shaped plumbing fixture for washing hands, dishwashing, during cooking operation.

2. The apparatus according to claim 1, wherein the one or more hot plates are made up of metal or ceramic material.

3. The apparatus according to claim 1, wherein the wooden case is made up of material, and wherein the material is selected from a group consisting of a fabric, wood, marble, metal, and plastic.

4. The apparatus according to claim 1, wherein the musical key board is configured for enabling the user to develop a melody, harmony, music or music album while preparing a recipe.

5. The apparatus according to claim 1, further comprises open space for keeping additional things required while cooking, and wherein the additional things comprise a butcher block, a chopping board, and a set of knives.

6. The apparatus according to claim 1, wherein the one or more shelves are customized in size and shape based on a user requirement.

7. The apparatus according to claim 1, further comprises a multi stage height adjustment unit, and wherein the multi stage height adjustment unit is configured to adjust a height of the one or more shelves.

8. The apparatus according to claim 1, further comprises a space provided at side surfaces or outer peripheral surface for offering a space for displaying advertisements, and promotions.

9. The apparatus according to claim 1, further comprises an electric oven accommodated or mounted within the wooden case, and wherein the electric oven is configured for providing a medium for cooking, baking or reheating the food.

10. The apparatus according to claim 1, further comprises a water tap attached to the sink, and wherein the water tap is configured for providing water for washing or cooking purposes.
